(19) United States
(12) Patent Application Publication
(10) Pub. No.: US 2009/0101306 A1
(43) Pub. Date: Apr. 23, 2009

(54) Heat Exchanger System

(76) Inventors: Bradley E. Reis, Westlake, OH (US); John Schober, Broadview Heights, OH (US); Prathib Skandakumaran, Cleveland, OH (US); Gregory Kramer, Lyndhurst, OH (US); Robert Anderson Reynolds, III, Bay Village, OH (US)

Correspondence Address: WADDEY & PATTERSON, P.C., 1600 DIVISION STREET, SUITE 500, NASHVILLE, TN, 37203, US

(21) Appl. No.: 11/876,499

(22) Filed: Oct. 22, 2007

(51) Int. Cl. F24D 3/16; F24H 9/06; H05B 3/44

(52) U.S. Cl. 165/56; 165/49; 219/544

(57) ABSTRACT

A heat exchanger system, especially for a room, including a thermal element comprising a surface; a heat spreader comprising at least one sheet of compressed particles of exfoliated graphite having a density of at least about 0.6 g/cc and a thickness of less than about 10 mm, and further comprising a first side and a second side, wherein the heat spreader is positioned relative to the thermal element such that the heat spreader is at least partially wrapped around the thermal element so that the first side of the heat spreader is in a thermal transfer relationship with a portion of the thermal element surface.

### BACKGROUND OF THE INVENTION

1. Technical Field

The present invention relates to an improved heat exchanger system, especially a radiant heating system which provides for greater and more uniform and efficient heat flow into the space heated by the radiant heating system. More particularly, the inventive radiant heating system provides a heat spreader which comprises at least one sheet of compressed particles of exfoliated graphite, which is in thermal contact with a thermal element such as a radiant heating element to improve the performance thereof.

2. Background Art

Heat exchanger systems, which include so-called radiant heating systems such as radiant floor heating and radiant wall heating systems as well as radiant cooling systems and solar heating panels, are techniques of providing for thermal transfer between two media (generally a thermal element and the air in a room), such as for heating or cooling rooms in a dwelling or commercial building for human and creature comfort. More specifically, radiant heating warms people directly through radiation, as well as the surfaces of a room: the floor, the walls, the furniture, which become heat sinks, slowly giving off their warmth to the cooler surroundings. People and creatures in the room then absorb this heat as needed. While this disclosure will focus on radiant heating systems, radiant cooling systems and solar panels which function in an equivalent manner (except that in the case of solar panels, the “direction” of thermal transfer is reversed: heat from the environment (i.e., the sun) is transferred to the thermal element) are also within the contemplation of this invention.

In a radiant floor heating system, the warm temperatures are kept at floor level and radiate upwards; as such, “hot pockets” of air formed at the ceiling level are avoided, since the heating system does not employ circulating air. Indeed, with radiant floor heating, one experiences cooler temperatures at head level and warmer temperatures at foot level, which many find to be superior in comfort and warmth.

Radiant heating systems are alternatives to the conventional heating systems such as forced hot air, discrete radiators, and baseboards, and can be either electric (i.e., use a resistance element) or hydronic (i.e., use heated fluid, especially water). The typical electric radiant heating system consists of a resistance element with the appropriate wiring and associated circuitry. The typical hydronic radiant heating system consists of a boiler for heating water, a pump, a supply pipe, a flexible heating pipe embedded throughout the floor of the room to be heated, a return pipe, and a thermostat for regulating the boiler. Hydronic systems have been designed for applications such as slab-on-grade, thin-slab, underfloor staple-up, etc., as can be seen in the Radiant Panel Association web site (as www.radiantpanelassociation.org). Heated water is pumped from the boiler, through the supply pipe, the heating pipe, and the return pipe back to the boiler. As noted, these systems have several advantages over other heating systems, and provide uniform heat to a room. And because the source of the heat is not localized, such as with a forced hot air, discrete radiator, or baseboard system, the heating water only has to be heated to a temperature that is slightly above the desired room temperature. For example, if the desired room temperature is 70° F., the water may only have to be heated to about 90° F., depending upon the outside temperature, as opposed to about twice that for other heating systems.

Radiant heating systems utilize a heating element within a floor or wall structure to carry and distribute heat without any visible radiators or heating grills. They generally do so by embedding the heating element such as tubing, especially a strong, flexible plastic tubing such as cross-linked polyethylene, referred to as PEX tubing, in a material such as a flooring intermediary substrate; for instance, in radiant floor heating, the tubing can be embedded in a single continuous horizontal concrete slab poured below the finished flooring, although applications using lighter weight materials like Styrofoam® materials have also been employed. Warm water is circulated through the tubing and the heat in the circulated fluid flowing through the tubing is transferred to the concrete slab by conduction. The concrete stores and radiates the heat, thereby warming the air as well as people and objects in the room, rather than only the air in the room, and thus can be more cost effective and can reduce heat loss. Further, such systems may be used for cooling wherein colder or cool water is run through the system; such cooling systems may be embedded in walls or ceilings, for example.

In practice, such systems can be formed by providing a subfloor, running tubing over the subfloor, and then pouring a single continuous concrete or gypsum slab, such as Maxxon Corporation's THERMA-FLOOR® material, around and over the tubing. A synthetic material is generally used for the tubing, such as polyethylene or polybutylene, which has the advantage of not expanding and contracting with fluctuations in temperature. When the concrete or gypsum hardens, it acts as the thermal mass for the system. The concrete or gypsum underlayment or slab is poured in liquid form across the entire surface area and cures to encase the tubing.

One drawback to the use of radiant heating systems is the cost involved in providing a sufficient array of tubing across the surface to be heated to provide the desired uniformity of heating. For example, even tubing arrayed with a typical pitch of 6-12 inches shows significant temperature non-uniformity at the flooring level, a fact which can often be noticed and felt by users directly when walking on a floor. In addition, the inefficiency of heat transfer from the tubing itself forces the fluid flowing therethrough to be heated to a higher temperature in order to transfer sufficient heat to the room, rendering the system less energy efficient. Thus, maximization of the heat provided from a radiant heating system, reducing energy usage, and providing improved uniformity and spreading of the heat provided in the radiant heating system tubing is desired.

In U.S. Pat. No. 7,132,629, Guckert et al. describe a “lightweight heat-conducting plate” in which the tubing of a radiant heating system is embedded. The Guckert et al. “plate” comprises a low density mat of compressed particles of exfoliated graphite. The Guckert et al. system is also cumbersome because it is thick and difficult to transport, and requires embedding the tubes in the graphite mat, with concomitant particulation concerns, etc. In a development which provides surprising advantages over the Guckert et al. use of exfoliated graphite, U.S. Patent Publication No. US 2006/0272796, the disclosure of which is incorporated herein by reference, discloses a flooring substrate that is in thermal contact with both a radiant heating element and a high-density sheet of compressed particles of exfoliated graphite, such that the sheet of compressed particles of exfoliated graphite reduces temperature variations on a floor covering overlaying the radiant heating system and maximizes heat transfer to the floor due to its flexibility and conformability with the floor.

Graphites are made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size, the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional such as thermal and electrical conductivity.

Briefly, graphites may be characterized as laminated structures of carbon, that is, structures consisting of superposed layers or laminae of carbon atoms joined together by weak Van der Waals forces. In considering the graphite structure, two axes or directions are usually noted, to with, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak Van der Waals forces. Natural graphites can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to commercially as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal conductivity due to orientation of the expanded graphite particles and graphite layers substantially parallel to the opposed faces of the sheet resulting from high compression, making it especially useful in heat spreading applications. Sheet material thus produced has excellent flexibility, good strength and a high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.04 g/cc to about 2.0 g/cc.

The flexible graphite sheet material exhibits an appreciable degree of anisotropy due to the alignment of graphite particles parallel to the major opposed, parallel surfaces of the sheet, with the degree of anisotropy increasing upon compression of the sheet material to increase orientation. In compressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

Accordingly, what is desired is a material and system for improving the uniformity of heat provided from a radiant heating system, as well as the heat flux obtained from a radiant heating system, making use of the anisotropic properties of one or more sheets of compressed particles of exfoliated graphite.

### SUMMARY OF THE INVENTION

In one embodiment of the present invention, a heat spreader for a heat exchanger system comprising a thermal element such as a radiant heating element is provided, where the heat spreader comprises at least one sheet of compressed particles of exfoliated graphite.

In another embodiment of the invention, the inventive heat spreader is in thermal contact with the “underside” of the thermal element (underside, with respect to the surface to be heated, cooled, etc.), to maximize heat flux between the thermal element and the environment with which thermal transfer is to occur.

In another embodiment of the invention specific to a radiant heating system, the inventive heat spreader is in contact with the “underside” of the radiant heating element (underside, with respect to the surface to be heated), to maximize heat flux from the heating element into the room to be heated.

Yet another embodiment of the present invention provides a heat spreader which improves the heat flux from a radiant heating system, and which thereby enables the use of fewer, more widely spaced heating element loops or a lower temperature or energy consumption for such heating elements.

In still another embodiment of the invention, a heat spreader which comprises at least one sheet of compressed particles of exfoliated graphite having a density of at least about 0.6 grams per cubic centimeter (g/cc) is disposed in thermal contact with the thermal element of a heat exchanger system, as well as the surface at which thermal transfer it to occur, such as the flooring of the room to be heated by the radiant heating system.

Another embodiment of the invention is where the inventive heat spreader has a density of at least about 1.1 g/cc, and most preferably at least about 1.5 g/cc.

In yet another embodiment of the present invention, a heat spreader which comprises at least one sheet of compressed particles of exfoliated graphite having a thermal conductivity parallel to the major surfaces of the at least one sheet of at least about 140 watts per meter-degree Kelvin (W/m-K) is disposed in thermal contact with the heat element of a radiant heating system, as well as the flooring of the room to be heated by the radiant heating system.

Still another embodiment of the invention is where the inventive heat spreader has a thermal conductivity of at least about 220 W/m-K, and most preferably at least about 300 W/m-K.

In another embodiment of the invention, the thermal element(s) of a heat exchanger for a radiant heating system are disposed in grooves or slots formed in an insulating material, between which is positioned the inventive heat spreader.

These objects and others which will be apparent to the skilled artisan upon reading the following description, can be achieved by providing a heat exchanger system, which includes a thermal element comprising a surface; a heat spreader comprising at least one sheet of compressed particles of exfoliated graphite having a density of at least about 0.6 g/cc, preferably it has a density of at least about 1.1 g/cc, and a thickness of less than about 10 mm, and further comprising a first side and a second side, wherein the heat spreader is positioned relative to the thermal element so that the heat spreader is at least partially wrapped around the thermal element such that the first side of the heat spreader is in a thermal transfer relationship with a portion of the thermal element surface.

The inventive heat exchanger system can also include a substrate with a recess dimensioned to accommodate the thermal element, wherein the substrate is disposed adjacent the second side of the heat spreader, such that the heat spreader is positioned between the thermal element and the substrate, and wherein the substrate has a thermal conductivity of less than about 2.0 W/m-K. Moreover, the heat spreader can comprise two components, a first component and a second component, where the first element of the heat spreader is positioned between the thermal element and the substrate. The first component of the heat spreader can be formed of aluminum or another metal. In some situations, the second component of the heat spreader extends across the recess such that the second component of the heat spreader is not positioned between the thermal element and the substrate at the recess. In a related embodiment, especially in an under-floor system, there may be no substrate but, rather, open space. In one embodiment, the heat exchanger system is a solar panel.

Another aspect of the invention relates to a heat exchanger system having a substrate comprising a recess; a heat spreader comprising at least one sheet of compressed particles of exfoliated graphite with a density of at least about 0.6 g/cc and a thickness of less than about 10 mm, wherein the heat spreader extends into the recess of the substrate to form a substrate/spreader recess which is dimensioned to accommodate a thermal element. In other words, the heat spreader is within the recess of the substrate and, therefore, as recess is formed by the heat spreader as it sits within the recess of the substrate, to form what is called the substrate/spreader recess. The heat spreader can be formed of two components, a first component and a second component, where the first element of the heat spreader cooperates with the substrate to form the substrate spreader recess.

In another aspect, the present invention relates to a heat exchanger system having a structural element having a first surface and a second surface; a thermal element positioned proximate to the second surface of the structural element and having a portion disposed toward the second surface of the structural element and a portion disposed away from the structural element, with respect to each other; a heat spreader comprising at least one sheet of compressed particles of exfoliated graphite, wherein the heat spreader is positioned in a thermal transfer relationship with both the second surface of the structural element and the thermal element, and further wherein the heat spreader is positioned in thermal transfer relationship with the portion of the thermal element disposed away from the second surface of the structural element.

Still another aspect of the invention relates to a radiant heating system for a room, comprising (a) a room comprising a structural element having a first surface and a second surface, wherein the first surface comprises at least one of the floor, wall or ceiling of the room; (b) a thermal element, such as a heating element, positioned adjacent the second surface of the structural element and having a portion disposed toward the second surface of the structural element and a portion disposed away from the structural element, with respect to each other; and (c) a heat spreader comprising at least one sheet of compressed particles of exfoliated graphite, wherein the heat spreader is positioned in a thermal transfer relationship with both the second surface of the structural element and the heating element, and further wherein the heat spreader is positioned in thermal transfer relationship with a portion of the heating element disposed away from the second surface of the structural element.

Another aspect of the invention involves providing a heat exchanger system, comprising (a) a structural element having a first surface and a second surface; (b) a thermal element positioned adjacent the second surface of the structural element and having a portion disposed toward the second surface of the structural element and a portion disposed away from the structural element, with respect to each other; and (c) a heat spreader comprising at least one sheet of compressed particles of exfoliated graphite, wherein the heat spreader is positioned in a thermal transfer relationship with both the second surface of the structural element and the thermal element, and further wherein the heat spreader is positioned in thermal transfer relationship with a portion of the thermal element disposed away from the second surface of the structural element.

In one embodiment of the invention, the heat spreader comprises two elements, one element of which is in thermal transfer relationship with the portion of the thermal element disposed away from the second surface of the structural element. Preferably the at least one sheet of compressed particles of exfoliated graphite has a density of at least about 0.6 g/cc, more preferably at least about 1.1 g/cc, or even 1.5 g/cc. In addition, the at least one sheet of compressed particles of exfoliated graphite may have an in-plane thermal conductivity of at least about 140 W/m-K, more preferably at least about 220 W/m-K, or even as high as 300 W/m-K or higher.

The thermal transfer system can also include a substrate disposed proximate to the second surface of the structural element such that the heat spreader is positioned between the substrate and the structural element, wherein the substrate is highly insulative, that is, it has a thermal conductivity of less than about 2.0 W/m-K, more preferably less than about 0.10 W/m-K.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principles and operations of the invention.

### BRIEF DESCRIPTION OF THE DRAWINGS

FIG. 1 is a partial cross-sectional view of a radiant heating system in accordance with the present invention.

FIG. 2 is a partial cross-sectional view of an alternate embodiment of the radiant heating system of FIG. 1.

FIG. 3 is a partial cross-sectional view of still another alternate embodiment of the radiant heating system of FIG. 1.

FIG. 4 is a partial cross-sectional view of yet another alternate embodiment of the radiant heating system of FIG. 1.

FIG. 5 is a top schematic view of test apparatus for comparative testing of the present invention.

FIG. 6 is a cross-sectional view of the test apparatus of FIG. 5, taken along lines 6-6.

### DETAILED DESCRIPTION OF THE PREFERRED EMBODIMENT

As noted, the inventive heat exchanger system heat spreader is advantageously formed of at least one sheet of compressed particles of exfoliated graphite. While this disclosure is written in terms of an embedded hydronic radiant floor heating system, it will be understood that it is meant to relate also to other types of heat exchanger systems, including other types of radiant floor heating systems, such as wall or ceiling systems, resistance systems, under-floor staple up systems; cooling systems; and solar panels, for which the concepts taught herein will also apply.

Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095} \qquad$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as graphite prepared by chemical vapor deposition, high temperature pyrolysis of polymers, or crystallization from molten metal solutions and the like. Natural graphite is most preferred.

The graphite starting materials used in the present invention may contain non-graphite components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has a purity of at least about eighty weight percent. More preferably, the graphite employed for the present invention will have a purity of at least about 94%. In the most preferred embodiment, the graphite employed will have a purity of at least about 98%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 350 pph and more typically about 40 to about 160 pph. After the flakes are intercalated, any excess solution is drained from the flakes and the flakes are water-washed. Alternatively, the quantity of the intercalation solution may be limited to between about 10 and about 40 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1,10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 250 to 125° C. to promote reaction of the reducing agent and intercalant coating. The heating period is up to about 20 hours, with shorter heating periods, e.g., at least about 10 minutes, for higher temperatures in the above-noted range. Times of one half hour or less, e.g., on the order of 10 to 25 minutes, can be employed at the higher temperatures.

The thusly treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets that, unlike the original graphite flakes, can be formed or embossed with structures, including flow field grooves or channels along one or both of the surfaces thereof.

Compressed exfoliated graphite materials, such as graphite sheet and foil, are coherent, with good handling strength, and are suitably compressed, e.g. by roll pressing, to a thickness of about 0.05 mm to 3.75 mm and a typical density of about 0.4 to 2.0 g/cc or higher. Indeed, in order to be consider “sheet,” the graphite should have a density of at least about 0.6 g/cc, and to have the flexibility required for the present invention, it should have a density of at least about 1.1 g/cc, more preferably at least about 1.5 g/cc. While the term “sheet” is used herein, it is meant to also include continuous rolls of material, as opposed to individual sheets.

If desired, sheets of compressed particles of exfoliated graphite can be treated with resin and the absorbed resin, after curing, enhances the moisture resistance and handling strength, i.e. stiffness, of the graphite article as well as “fixing” the morphology of the article. Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, fluoro-based polymers, or mixtures thereof. Suitable epoxy resin systems include those based on diglycidyl ether of bisphenol A (DGEBA) and other multifunctional resin systems; phenolic resins that can be employed include resole and novolac phenolics. Optionally, the flexible graphite may be impregnated with fibers and/or salts in addition to the resin or in place of the resin. Additionally, reactive or non-reactive additives may be employed with the resin system to modify properties (such as tack, material flow, hydrophobicity, etc.).

As noted above, the current invention is a radiant heating system comprising a heat spreader which comprises at least one sheet of compressed particles of exfoliated graphite. The heat spreader should have a density of at least about 0.6 g/cc, more preferably at least about 1.1 g/cc, most preferably at least about 1.5 g/cc. From a practical standpoint, the upper limit to the density of the graphite sheet heat spreader is about 2.0 g/cc. The heat spreader (even if made up of more than one sheet of compressed particles of exfoliated graphite) should be no more than about 10 mm in thickness, more preferably no more than about 2 mm and most preferably not more than about 1 mm in thickness.

In the practice of the present invention, a plurality of graphite sheets may be laminated into a unitary article for use as the inventive heat spreader, provided the laminate meets the density and thickness requirements set forth hereinabove. The sheets of compressed particles of exfoliated graphite can be laminated with a suitable adhesive, such as pressure sensitive or thermally activated adhesive, therebetween. The adhesive chosen should balance bonding strength with minimizing thickness, and be capable of maintaining adequate bonding at the service temperature at which heat dissipation is sought. Suitable adhesives would be known to the skilled artisan, and include phenolic resins.

The graphite sheet(s) which make up the inventive heat spreader should have a thermal conductivity parallel to the plane of the sheet (referred to as “in-plane thermal conductivity”) of at least about 140 W/m-K for effective use. More advantageously, the thermal conductivity parallel to the plane of the graphite sheet(s) is at least about 220 W/m-K, most advantageously at least about 300 W/m-K. Of course, it will be recognized that the higher the in-plane thermal conductivity, the more effective the heat spreading characteristics of the inventive heat spreader. From a practical standpoint, sheets of compressed particles of exfoliated graphite having an in-plane thermal conductivity of up to about 600 W/m-K are all that are necessary. The expressions “thermal conductivity parallel to the plane of the sheet” and “in-plane thermal conductivity” refer to the fact that a sheet of compressed particles of exfoliated graphite has two major surfaces, which can be referred to as forming the plane of the sheet; thus, “thermal conductivity parallel to the plane of the sheet” and “in-plane thermal conductivity” constitute the thermal conductivity along the major surfaces of the sheet of compressed particles of exfoliated graphite.

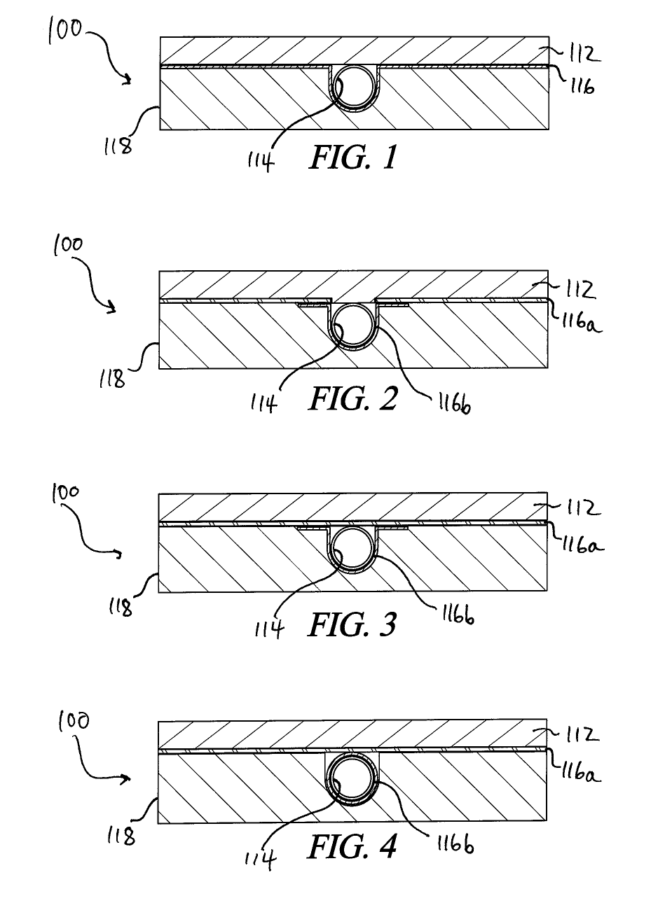

Referring now to the drawings, FIG. 1 schematically illustrates a radiant floor heating system 100. Although the present invention is described primarily in the context of a radiant floor heating system, it will be understood that the principles hereof may be applied to heating or cooling systems embedded in any of the boundary structures such as walls or ceiling as well as other similar heat exchanger systems like solar panels (not shown).

Flooring system 100 includes flooring 112, which has a surface through which heat (or cooling) is provided to the room in which flooring system 100 is located. (of course, in a solar panel, the equivalent to flooring 112 would be a heat absorption panel, such as a glass panel, which is exposed to sunlight). As noted, if system 100 is used as a wall or ceiling heating system, then flooring 112 is actually the wall or ceiling of the room. A thermal element 114, which can be a heating or cooling element, depending on the specific application, is in heat transfer relationship with flooring 112. By heat transfer relationship is meant that thermal energy is transferred from one article or entity to another. Although the following description primarily refers to a heating element as thermal element 114, it will be understood that this includes cooling elements. Thermal element 114 could more generally be referred to as a heat transfer element which can either heat or cool, and also includes those situations where heat transfer element 114 is heated by its surroundings, such as in solar panel applications.

Thermal element 114 may be any available type of heating or cooling element, including but not limited to electrical resistance wiring heating elements and tubing networks for carrying heat transfer fluids. Flooring 112 can be any conventional flooring of a type suitable for use with the selected heating element. Suitable thermal elements 114 and flooring 112 are described in further detail below.

A heat spreader 116 which comprises at least one sheet of compressed particles of exfoliated graphite is in heat transfer relationship with flooring 112, and thus, thermally engages flooring 112. It should be noted that “thermally engages” can include a conductive, convective, or radiative relationship (the latter two meaning that the heat spreader 116 need not be in physical contact with flooring 112 as described further below). A flooring substrate 118, described in more detail hereinbelow, lies below flooring 112, with heat spreader 116 positioned between flooring substrate 118 and flooring 112.

It will be appreciated that flooring 112 need not directly engage heat spreader 116, and may be separated therefrom by various layers, such as padding for a carpet for example. Thus when one layer is described as overlying another, that does not require that they physically touch each other, unless further specific language so states. Flooring 112 may be any conventional floor covering including but not limited to vinyl flooring, carpet, hardwood flooring, cement, and ceramic tile.

Heat spreader 116 is also in heat transfer relationship with thermal element 114. Thermal element 114 may be that found in any conventional radiant heating or heat exchanger system. For example, thermal element 114 may be electrical resistance wiring heating elements such as those utilized in ThermoTile™ radiant floor heating systems available from ThermoSoft International Corporation of Buffalo Grove, Ill. Such electrical resistance wiring type thermal element 114 is often utilized with flooring substrates 118 of a type in which thermal element 114 can be completely embedded. For example, if the flooring 112 is to be ceramic tile type flooring, the electrical resistance type thermal element 114 will typically be embedded in a flooring substrate 118 comprising a layer of cement or thin-set mortar. Alternatively, if flooring 112 is to be vinyl flooring or carpet, the electrical resistance type thermal element 114 is often be used in conjunction with felt or other conformable intermediary layer.

If a thermal element 114 of the type comprising a tubing network for carrying a heat transfer fluid such as hot water is selected, it may for example be of the type available from Uponor Wirsbo Company of Apple Valley, Minn. Such systems typically use PEX tubing, which may for example be embedded in a concrete or Styrofoam® foam substrate 118. Such systems may also use other tubing materials such as copper. While generally round in cross-section, the tubing employed as thermal element 114 can also assume other cross-sectional shapes, such as oval, square, rectangular, etc. Tubing type thermal element 114 may also be utilized with conventional wooden substrates 118. In such cases, the tubing is attached to the underside of a conventional plywood or oriented strand board wooden sub floor which spans conventional wooden floor stringers (not shown) or even in so-called joist bay convection plates where convection in the joist space is utilized (also not shown). In this embodiment the wooden sub floor and stringers comprise substrate 118. Another system for which the inventive heat transfer system is applicable is a so-called joist bay convection plate system, which, rather than relying on conduction to the floor, relies on convection and/or radiation in the joist space.

In a preferred embodiment, substrate 118 comprises an insulating material, especially a relatively insulating material, such as Styrofoam® polystyrene foam. The thermal conductivity of substrate 118, when an insulating material is used, should be less than about 2.0 W/m-K, more preferably less than about 0.1 W/m-K and most preferably less than about 0.05 W/m-K (again, while there is no technical lower limit to thermal conductivity for use as substrate 118, a practical lower limit can be seen as about 0.025 W/m-K), Preferably, but not necessarily, for practical concerns such as transport and installation, substrate 118 is lightweight, by which is meant having a density of less than about 0.3 g/cc, more preferably less than about 0.1 g/cc; while generally the lower the density the better, the density of substrate 118 need not be any lower than about 0.01 g/cc. For example, Styrofoam® material has a thermal conductivity of about 0.033 W/m-K and a density of less than about 0.04-0.05 g/cc. As such, substrate 118 can help ensure that as much thermal energy as possible is transferred from thermal element 114 to flooring 112. A further example of the benefits of the use of a lightweight insulating material like Styrofoam® foam is the ability to mold or otherwise form grooves, recesses, or slots in the surface of the material, to permit thermal element 114 to be laid into such grooves, recesses or slots. In this way, the transfer of thermal energy from thermal element 114 to flooring 112 is not obstructed and thermal element 114 can assume and retain a desired pattern. Moreover, the use of a lightweight insulating material as substrate 118 permits a lightweight prefabricated radiant heating system panel comprising substrate 118 and heat spreader 116, and/or thermal element 114 to be prepared off-site and installed in the building in which it is intended.

As noted, heat spreader 116 comprises at least one sheet of compressed particles of exfoliated graphite, and is positioned between substrate 118 and flooring 112. As such, since heat spreader 116 is in heat transfer relationship with both thermal element 114 and flooring 112, heat spreader 116 will spread the thermal energy (be it through heating or cooling) to or from thermal element 114 more uniformly across the surface of flooring 112. Most advantageously, heat spreader 116 is in heat transfer relationship with the portion of thermal element 114 which is furthest from flooring 112. In other words, when viewed in the orientation of FIGS. 1-4, heat spreader 114 should be at least partially wrapped around thermal element 114 and thus be in heat transfer relationship (most preferably in actual physical contact) with a portion of the surface of thermal element 114, preferably the underside of thermal element 114. In this way, heat spreader 116 improves the heat flux from thermal element 114 by providing a pathway for thermal energy from the surfaces or portions of thermal element 114 which are in the remotest heat transfer relationship (i.e., the most physically removed) to flooring 112. Moreover, the flexibility and conformability of heat spreader 116 can improve the thermal transfer with flooring 112, which is an important advantage from an efficiency standpoint. In addition, since heat spreader 116 has a relatively uniform cross-sectional thickness and density, the advantageous physical properties of heat spreader 116 are uniform across its entire area.

In one embodiment of the invention illustrated in FIG. 1, given the flexible nature of the sheets of compressed particles of exfoliated graphite used to form heat spreader 116, heat spreader 116 can be positioned between substrate 118 and flooring 112, and extend under thermal element 114 (it will be recognized that the term “under” when applied to wall or ceiling heating systems, refers to that portion of thermal element 114 facing away from the room in which radiant heating system 100 is located; in solar panel applications, “under” refers to that portion of thermal element 114 facing away from the sun). Alternatively, heat spreader 116 can be formed of two discrete components, first heat spreader component 116a and second heat spreader component 116b, as illustrated in FIGS. 2 and 3. First heat spreader component, 116a, comprises at least one sheet of compressed particles of exfoliated graphite, as described above, and is positioned between substrate 118 and flooring 112, but does not extend under thermal element 114. Rather, first heat spreader component 116a does not extend into the area in which thermal element 114 is positioned, as shown in FIG. 2; or, first heat spreader component 116a extends completely across the upper surface of thermal element 114 and, thus, is in good thermal contact with the upper portion of thermal element 114. Second heat spreader component 116b is a discrete component which thermally (and, advantageously physically) contacts and is at least partially wrapped around thermal element 114 or surfaces thereof, including portions of the underside or sides of thermal element 114, and thermally contacts (most preferably physically contacts) first heat spreader component 116a, as shown in both FIGS. 2 and 3. Second heat spreader component 116b can be formed of at least one sheet of compressed particles of exfoliated graphite, or it can be a different material, such as an isotropic material like a metal like aluminum. In under-floor arrangements it may also be advantageous to have second heat spreader 116b only partially surrounding the sides of thermal element 114 (not shown), allowing thermal element 114 to be installed and/or attached to second heat spreader component 116b, which is in turn installed or otherwise attached to first heat spreader component 116a, which is installed between joists on the underside of the sub-floor.

In yet another embodiment, illustrated in FIG. 4, second heat spreader component 116b can completely envelope, or extend about, thermal element 114, provided second heat spreader element 116b remains in heat transfer relationship (and, most advantageously, actual physical contact) with first heat spreader component 116a.

Without intending to limit the scope of the invention, the following examples illustrate the advantages and benefits of the use thereof.

### EXAMPLES

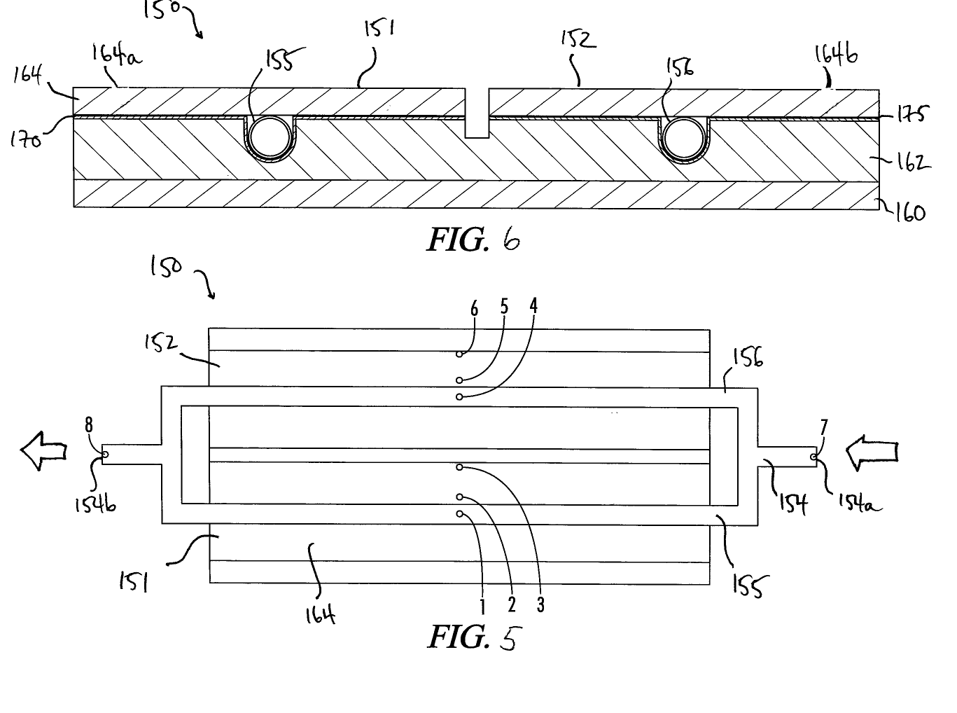

A test apparatus 150 is constructed and illustrated in FIGS. 5 and 6. Apparatus 150 includes a tubing 154, which is a water pipe having a 0.5 inch inner diameter and a 0.625 inch outer diameter, having an inlet 154a and an outlet 154b, and which is split into two equal branches, 155 and 156, as shown in FIG. 5. The temperature at inlet 154a is measured using thermocouple 7; the temperature at outlet 154b is measured using thermocouple 8. Each branch 155 and 156 of tubing 154 extends into a testing zone, one of which is denoted first testing zone 151 and the other of which is denoted second testing zone 152, as illustrated in FIG. 6. Each testing zone 151 and 152 is formed of an 18 mm thick sheet of plywood as a base 160, a 25 mm thick sheet of Styrofoam® insulation as a substrate 162, and an 18 mm thick sheet of plywood as a flooring 164. Each substrate 162 has a groove or recess formed therein through which extend branches 155 and 156 of tubing 154, respectively.

Testing zone 151 includes thermocouples 1, 2 and 3 to measure the temperature on the top surface 164a of plywood flooring 164 of testing zone 151. Similarly, testing zone 152 includes thermocouples 4, 5 and 6 to measure the temperature on the top surface 164a of plywood flooring 164 of testing zone 152 (with thermocouple 4 corresponding to the same location on flooring 164a of testing zone 152 as thermocouple 1 on flooring 164a of testing zone 151; thermocouple 5 corresponding to the same location on flooring 164a of testing zone 152 as thermocouple 2 on flooring 164a of testing zone 151; and thermocouple 6 corresponding to the same location on flooring 164a of testing zone 152 as thermocouple 3 on flooring 164a of testing zone 151).

In each test run, water flows through tubing 154 at a rate of 1.2 meters per second, with the inlet temperature measured at 7 as 53.5° C. and the outlet temperature measured at 8 as 50.8° C.

In a first test, a heat spreader formed of a sheet of compressed particles of exfoliated graphite having a thickness of 0.5 mm and an in-plane thermal conductivity of 450 W/m-K is positioned in testing zone 151 between flooring substrate 162 and flooring 164, and around tubing 154, as denoted in FIG. 6 as 170; an aluminum sheet having a thickness of 0.5 mm and a thermal conductivity of approximately 220 W/m-K is positioned in testing zone 152 between flooring substrate 162 and flooring 164, and around tubing 154, as denoted in FIG. 6 as 175. Ambient temperature (T_{ambient}) is 26.3° C. Water is flowed through tubing 154 as described above, and the temperatures permitted to equilibrate for one hour; the temperatures are then measured above flooring 164 using a thermal infrared camera. The results are shown in Table 1:

TABLE 1

| Thermocouple | Temperature |
|---|---|
| No. | (° C.) |
| 1 | 52.0 |
| 2 | 49.0 |
| 3 | 47.9 |
| 4 | 51.5 |
| 5 | 48.9 |
| 6 | 46.9 |

The average temperature (T_{avg}), as measured by a thermal infrared camera, for testing zone 151 is 35.8° C. and for testing zone 152 is 34.4° C. The heat flux for each testing zone 151 and 152 is then calculated using the formula:

q″=B(T_{avg}−T_{ambient})

where q″ is the heat flux and B is 6.7 W/m²K, representing the heat transfer coefficient that is best represented by the test setup, per DS/EN 1264-2.

As such, the heat flux for testing zone 151 is calculated as 64 W/m² and for testing zone 152 as 54 W/m², showing a 19% increase in heat flux by the use of the graphite heat spreader of the present invention, as compared to aluminum.

In a second test, the conditions of the first test are repeated, except that no heat spreader is present in testing zone 152 and T_{ambient} is 24.0° C. The average temperature (T_{avg}) for testing zone 151 is 34.1° C. and for testing zone 152 is 28.5° C. As such, the heat flux for testing zone 151 is calculated as 68 W/m² and for testing zone 152 as 30 W/m², showing a 127% increase in heat flux by the use of the graphite heat spreader of the present invention, as compared to no heat spreader.

Thus, it will be seen that the use of the heat spreader of the present invention, with its greater thermal contact with a heating element, can significantly improve the heat flux from a radiant heating system. Accordingly, it is possible to array the heating elements for the heating system farther apart, and/or lower the temperature of water flowing through radiant heating tubing, or the amount of energy provided to other types of heating elements, with resultant significant savings.

All cited patents and publications referred to in this application are incorporated by reference.

The invention thus being described, it will obvious that it may be varied in many ways. Such variations are not to be regarded as a departure from the spirit and scope of the present invention and all such modifications as would be obvious to one skilled in the art are intended to be included in the scope of the following claims.

What is claimed is:

1. A heat exchanger system, comprising:
(a) a thermal element comprising a surface;
(b) a heat spreader comprising at least one sheet of compressed particles of exfoliated graphite having a density of at least about 0.6 g/cc and a thickness of less than about 10 mm, and further comprising a first side and a second side, wherein the heat spreader is positioned relative to the thermal element so that the heat spreader is at least partially wrapped around the thermal element such that the first side of the heat spreader is in a thermal transfer relationship with a portion of the thermal element surface.

2. The heat exchanger system of claim 1, wherein the system further comprises a substrate with a recess dimensioned to accommodate the thermal element, wherein the substrate is disposed adjacent the second side of the heat spreader, such that the heat spreader is positioned between the thermal element and the substrate, and wherein the substrate has a thermal conductivity of less than about 2.0 W/m-K.

3. The heat exchanger system of claim 2, wherein the heat spreader comprises two components, a first component and a second component, further wherein the first component of the heat spreader is positioned between the thermal element and the substrate.

4. The heat exchanger system of claim 3, wherein the first element of the heat spreader comprises aluminum.

5. The heat exchanger system of claim 1, which comprises a solar panel.

6. The heat exchanger of claim 3, wherein the second component of the heat spreader extends across the recess such that the second component of the heat spreader is not positioned between the thermal element and the substrate.

7. The heat exchanger system of claim 1, wherein the at least one sheet of compressed particles of exfoliated graphite has a density of at least about 1.1 g/cc.

8. A heat exchanger system, comprising:
(a) a substrate comprising a recess;
(b) a heat spreader comprising at least one sheet of compressed particles of exfoliated graphite with a density of at least about 0.6 g/cc and a thickness of less than about 10 mm, wherein the heat spreader extends into the recess of the substrate to form a substrate/spreader recess which is dimensioned to accommodate a thermal element.

9. The heat exchanger system of claim 8, wherein the heat spreader comprises two components, a first component and a second component, further wherein the first component of the heat spreader cooperates with the substrate to form the substrate spreader recess.

10. The heat exchanger system of claim 9, wherein the first component of the heat spreader comprises aluminum.

11. A heat exchanger system, comprising:
(a) a structural element having a first surface and a second surface;
(b) a thermal element positioned proximate to the second surface of the structural element and having a portion disposed toward the second surface of the structural element and a portion disposed away from the structural element, with respect to each other;
(c) a heat spreader comprising at least one sheet of compressed particles of exfoliated graphite, wherein the heat spreader is positioned in a thermal transfer relationship with both the second surface of the structural element and the thermal element, and further wherein the heat spreader is positioned in thermal transfer relationship with the portion of the thermal element disposed away from the second surface of the structural element.

12. The heat exchanger system of claim 11, wherein the heat spreader comprises two components, one component of which is in thermal transfer relationship with the portion of the thermal element disposed away from the second surface of the structural element.

13. The heat exchanger system of claim 11, wherein the at least one sheet of compressed particles of exfoliated graphite has a density of at least about 0.6 g/cc.

14. The heat exchanger system of claim 13, wherein the at least one sheet of compressed particles of exfoliated graphite has a density of at least about 1.1 g/cc.

15. The heat exchanger system of claim 11, wherein the at least one sheet of compressed particles of exfoliated graphite has an in-plane thermal conductivity of at least about 140 W/m-K.

16. The heat exchanger system of claim 11, which further comprises a substrate disposed adjacent the second surface of the structural element such that the heat spreader is positioned between the substrate and the structural element, wherein the substrate has a thermal conductivity of less than about 2.0 W/m-K.

17. A radiant heating system for a room, comprising:
(a) a room comprising a structural element having a first surface and a second surface, wherein the first surface comprises at least one of the floor, wall or ceiling of the room;
(b) a thermal element positioned adjacent the second surface of the structural element and having a portion disposed toward the second surface of the structural element and a portion disposed away from the structural element, with respect to each other;
(c) a heat spreader comprising at least one sheet of compressed particles of exfoliated graphite having a density of at least about 0.6 g/cc and an in-plane thermal conductivity of at least about 140 W/m-K, wherein the heat spreader is positioned in a thermal transfer relationship with both the second surface of the structural element and the thermal element, and further wherein the heat spreader is positioned in thermal transfer relationship with the portion of the thermal element disposed away from the second surface of the structural element.

18. The radiant heating system of claim 17, wherein the at least one sheet of compressed particles of exfoliated graphite has an in-plane thermal conductivity of at least about 220 W/m-K.

19. The radiant heating system of claim 17, wherein the heat spreader comprises two components, one component of which is in thermal transfer relationship with the portion of the thermal element disposed away from the second surface of the structural element.
